(19) United States
(12) Patent Application Publication
(10) Pub. No.: US 2012/0097798 A1
(43) Pub. Date: Apr. 26, 2012

(54) INERTIAL MASS SUSPENSION

(76) Inventor: John H. Rust, SR., Edmond, OK (US)

(21) Appl. No.: 13/280,996

(22) Filed: Oct. 25, 2011

Related U.S. Application Data
(60) Provisional application No. 61/406,455, filed on Oct. 25, 2010.

(51) Int. Cl. B64G 1/40

(52) U.S. Cl. 244/171.5

(57) ABSTRACT

A craft, having at least two counter rotating rotors within, or a multi unit craft having two or more units as desired, with counter rotating rings, having the ability to store inertia, within the spinning rings, so as to enable the craft to either accelerate from the front or decelerate from the back of the Earth, relative to the absolute inertial frame of reference.

### CROSS REFERENCE TO RELATED APPLICATION

This application claims benefit to U.S. Provisional Application No. 61/406,455, filed Oct. 25, 2010, the entire contents of which are hereby incorporated herein by reference.

### BACKGROUND OF THE INVENTION

The present invention relates to inertia mass suspension and more particularly to resisting a change in velocity, of all particles that make up the spinning craft which slows down, to obey the conservation energy law, while the earth moves on.

### SUMMARY OF THE INVENTION

The invention comprises a disk-like space craft having a thickened hub. The craft is generally hollow and includes an outer shell rotatable with respect to an axial central shaft. An outer inertia rotor, at the perimeter of the shell, is connected by bearings and a plurality of spokes with the respective end portions of the shaft. An inner inertia rotor, disposed adjacent the outer rotor and rotatable with respect to the outer rotor, is similarly supported by spokes and bearings. The outer rotor supports a circular array of permanent magnets facing the inner rotor. Similarly, a circular array of electromagnets are supported by the inner rotor adjacent the series of permanent magnets. An electric circuit, connected with a source of electric energy and the electromagnets, utilize magnetic attraction and repulsion of the oppositely disposed magnets for rotating the inner rotor relative to the outer rotor and/or rotating the inner and outer rotors in opposing directions. A cylindrical cabin loosely surrounds the axial shaft intermediate its ends and is supported by pressure cylinders connected with the cabin and upper and lower endless rings in turn connected by arms with the respective end portions of the shaft.

The principal objects of the inventions are to provide a space craft, the ability to rise above the surface, when located on the backside of the earth, in its motion through space. By changing the spin axis of the craft from rotating in a three dimensional helix, to a two dimensional rotation, all particles, that make the craft, will continue to move with a constant velocity, the conservation of momentum law. That law, will slow the velocity of the craft at a greater velocity rate, than the Earths' gravitational force, of 4.9 meters in the first second, can accelerate the craft.

### BRIEF DESCRIPTION OF THE DRAWINGS

FIG. 1 is a side elevational view of the craft;

FIG. 2 is a top view of FIG. 1;

FIG. 3 is a fragmentary vertical cross sectional view, to a larger scale, taken substantially along the line 3-3 of FIG. 2;

FIG. 4 is a top view of the cabin looking in the direction of the arrows 4-4 of FIG. 3;

FIG. 5 is a side elevational view of FIG. 4 with the cabin stabilizing gyroscopes removed, illustrating by dotted lines, movement of the cabin for nutation control of the craft;

FIG. 6 is a vertical cross sectional view, to an enlarged scale, of bearings connecting the outer and inner rotors to the central support shaft;

FIG. 7 is a fragmentary vertical cross sectional view, to an enlarged scale, taken substantially along the line 7-7 of FIG. 2;

FIG. 8 is a fragmentary vertical cross sectional view taken substantially along the line 8-8 of FIG. 7;

FIG. 9 is a fragmentary vertical cross sectional view, to another scale, taken substantially along the line 9-9 of FIG. 2;

FIG. 10 is a diagram illustrating the relative position of the permanent magnets and electromagnets respectively supported by the outer and inner rotors;

FIG. 11 is a fragmentary diagram illustrating the position of the pilot windings relative to the electromagnets and permanent magnets; and

FIG. 12 is a wiring diagram.

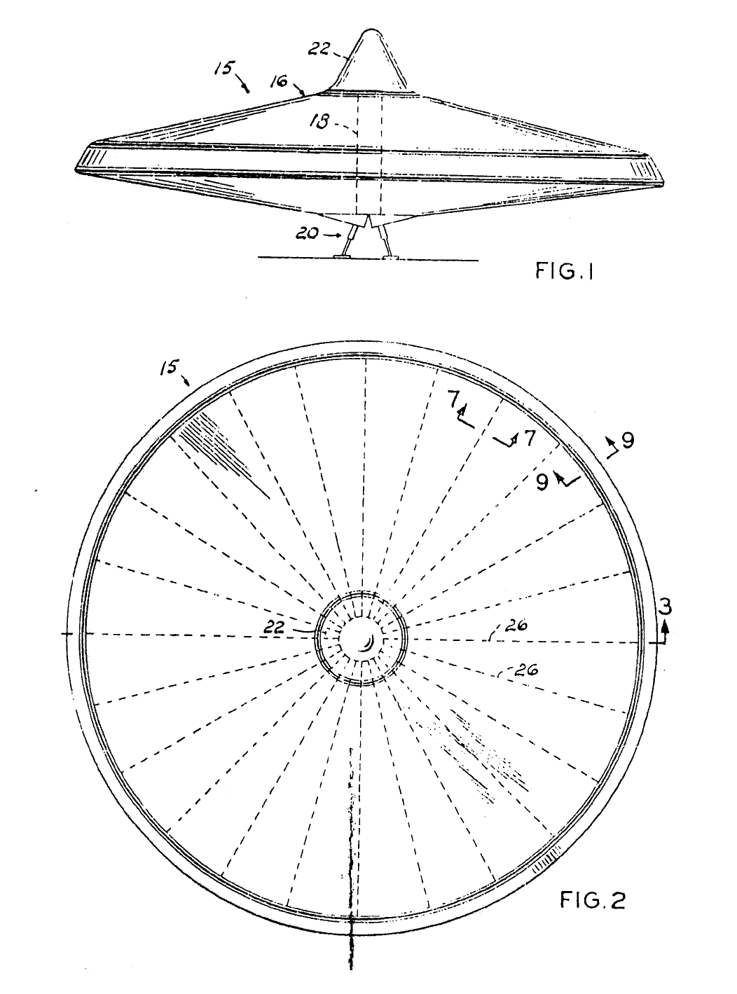

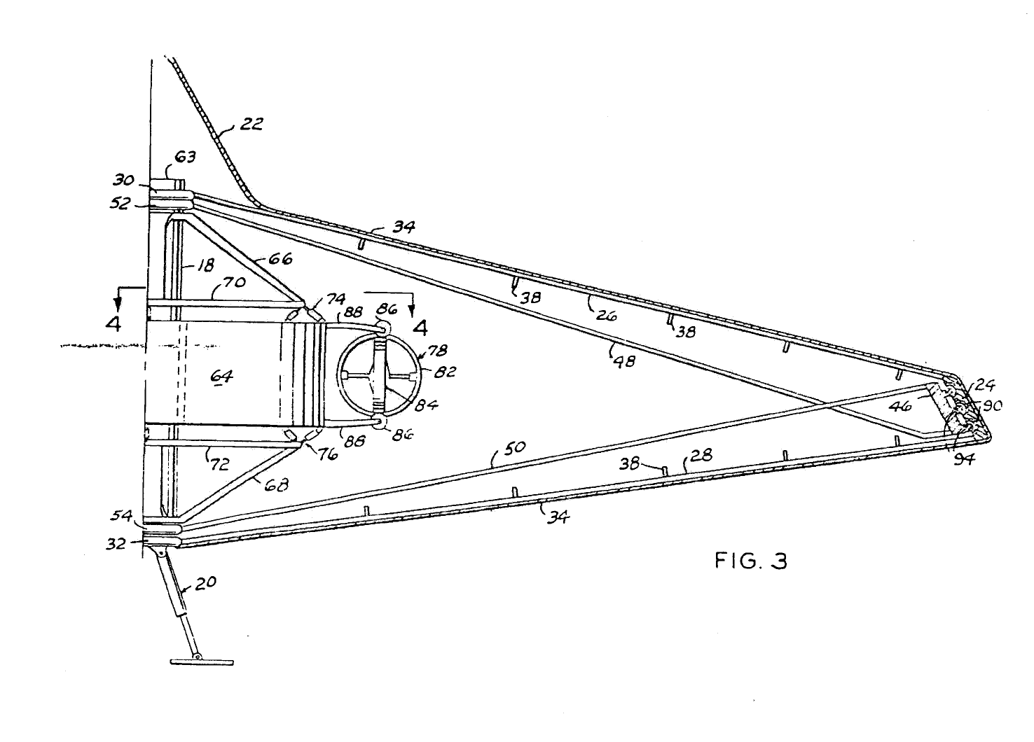

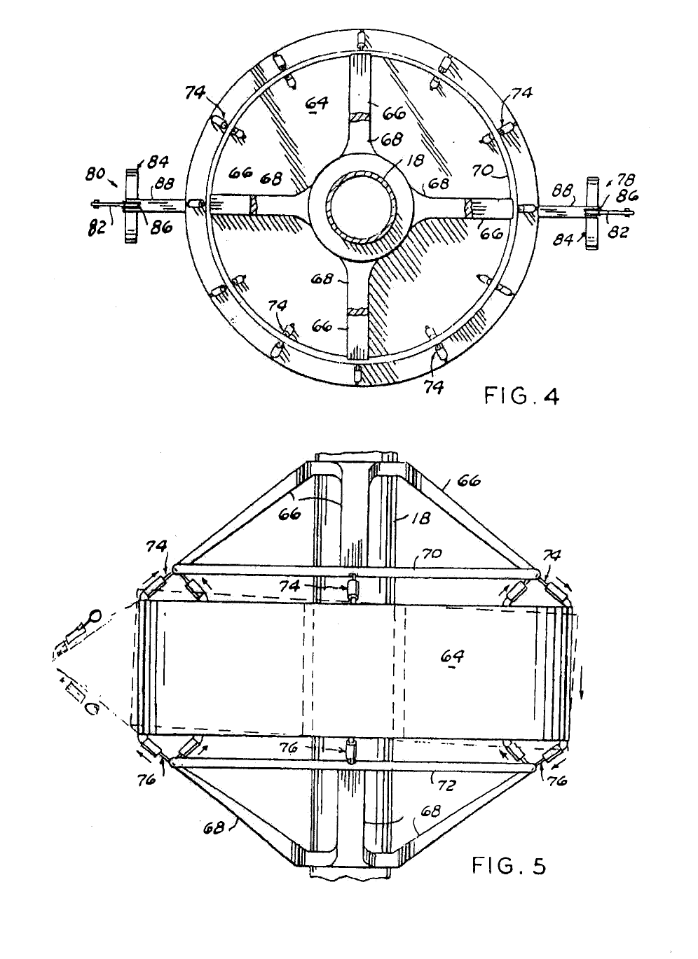

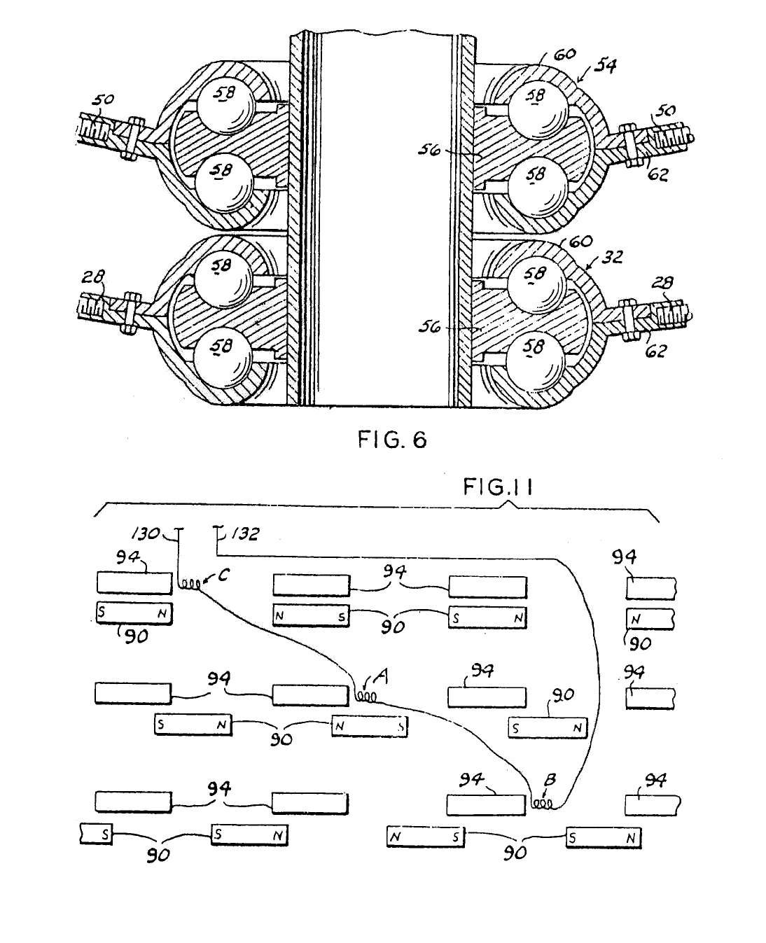

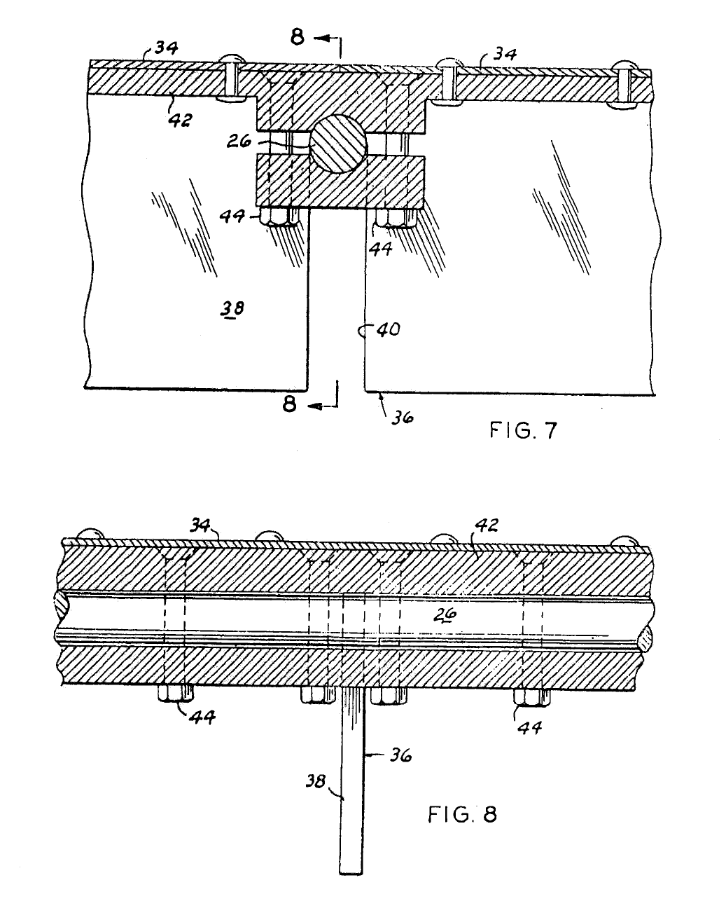

### DETAILED DESCRIPTION OF EXEMPLARY EMBODIMENT

Like characters of reference designate like parts in those figures of the drawings in which they occur.

The reference numeral 15 indicates the device, as a whole, which is thickened hub-like in general configuration. The device comprises a generally hollow, preferably evacuated, housing 16 surrounding an axial tubular shaft 18 supported by a plurality of retractable leg means 20 and having an axial upstanding observation dome 22. The housing 16 is formed by a circumferential outer inertia rotor 24 having a plurality of radially disposed upper and lower spokes 26 and 28 connecting it with a central shaft 18 by bearing means 30 and 32. A skin 34 overlies the respective upper and lower spokes and is secured thereto by stiffeners 36. The stiffeners 36 are T-shaped in transverse section (FIG. 8) and overlie the upper and lower spokes 26 and 28 in a plurality of juxtaposed circular arrays longitudinally of the spokes. The stems 38 of the stiffeners are notched from their depending ends, as at 40, for nesting the respective spoke 26 and 28 with the respective bar portions 42 of the stiffeners supporting the skin 34. A plurality of elongated bar clamps underlie and grip the respective spoke 26 or 28 by bolts 44. A second or inner circumferential inertia rotor 46 is disposed adjacent the inner limit of the outer rotor 24 and is similarly connected to the shaft 18 by similar bearing means 52 and 54 and upper and lower spoke-like rods 48 and 50.

Since the pairs of bearing means 30-52 and 32-54 are identical, only the bearing means 32-54 will be described in detail. These bearings are each ball bearings having a race 56 secured to the periphery of the shaft 18 with each race provided with vertically opposite circumferential recesses nesting a hemispherical portion of a plurality of balls 58. A bearing housing 60, similarly having vertically opposite circumferential arcuate recesses, overlie the opposite hemispherical portion of the respective balls. The housing 60 is provided with a circumferential flange 62 provided with cooperating recesses for bolt connection with the respective adjacent end of the housing spokes 28 and rods 50. The pairs of bearings 3052 and 32-54 thus permit angular rotation of the rotors 24 and 46 with respect to each other and the stationary shaft 18. A brake 63, on the upper end of the shaft 18, prevents rotation of the outer rotor 24 when desired.

Intermediate its ends, the shaft 18 is loosely surrounded by a cylindrical donut-like cabin 64. The cabin 64 is supported by a plurality of upper and lower radial arms 66 and 68, respectively, secured at one end to the respective end portions of the shaft 18 and secured at the other ends to a pair of endless rings 70 and 72 diametrically slightly smaller than the cabin. The endless rings 70 and 72 are in turn secured to the respective upper and lower surfaces of the cabin by radially disposed pairs of hydraulic cylinders 74 and 76, for the purposes presently explained.

A pair of stabilizing gyroscopes 78 and 80 are secured in diametric opposition to the perimeter of the cabin to prevent angular rotation of the cabin and shaft 18 about the spin axis when the inner and/or outer rotors are rotating. Each of the gyroscopes comprise a ring 82 journaling its rotating member 84 with the axis of the rotating member 84 perpendicular to the vertical axis of the cabin. The gyroscope supporting ring 82 is journalled by a pair of grooved pulleys 86 respectively supported by arms 88 projecting radially outward of the cabin perimeter from its upper and lower limits. The gyroscope rotating member 84 is driven by magnetic means as presently explained.

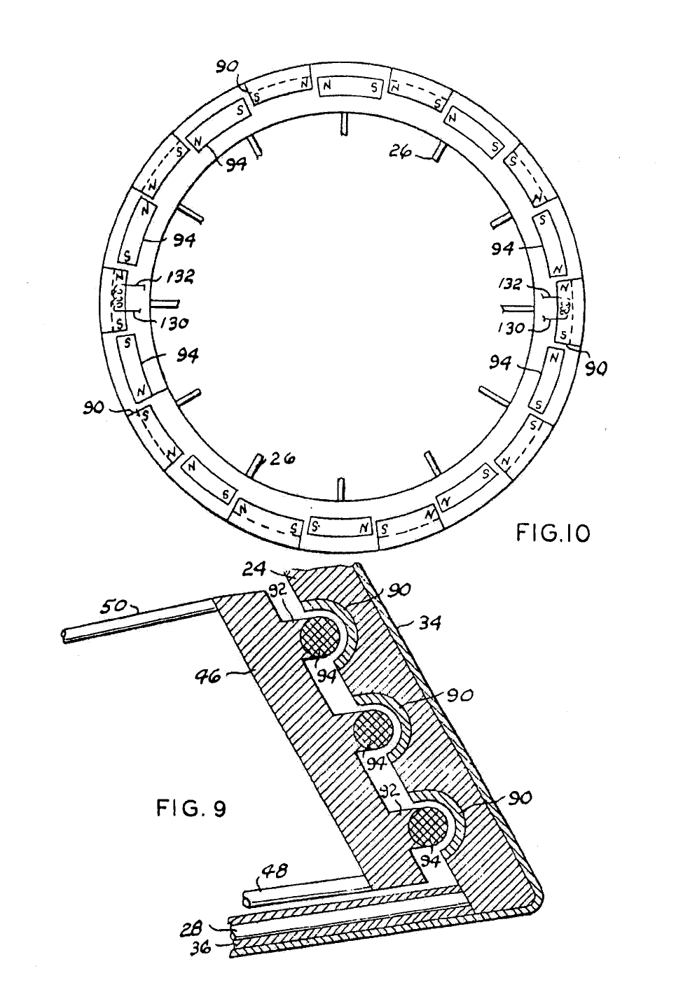

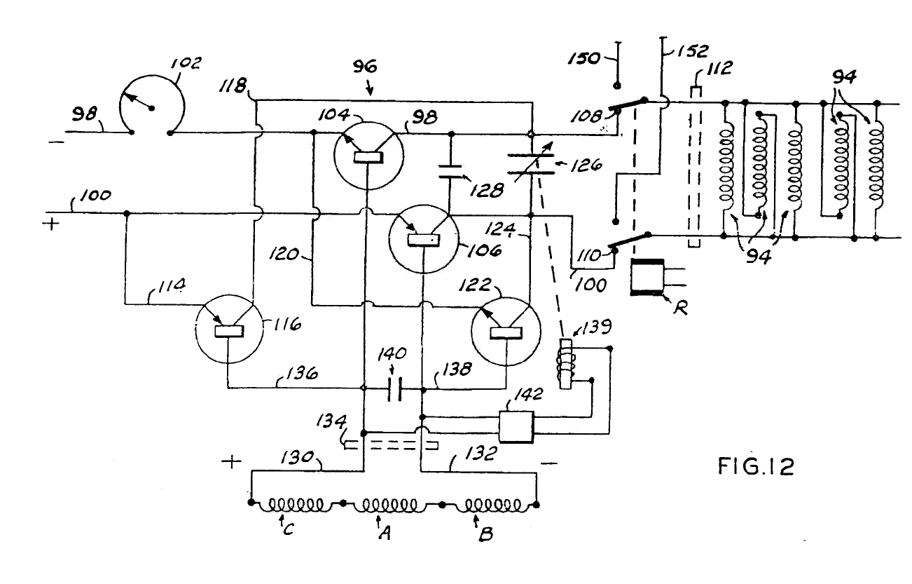

Referring more particularly to FIGS. 9 through 12, the outer rotor 24 supports a plurality of vertically spaced rows of circumferentially spaced permanent magnets 90. The magnets 90 in each row are arranged in end to end spaced relation with like poles disposed adjacent each other. Each of the magnets 90 are elongated U-shaped in transverse section disposed in cooperating recesses formed in the ring 24 with the legs of the respective U-shaped superposed and projecting toward the inner rotor 46. The inner rotor 46 is provided, on its perimeter, with a like plurality of circumferentially spaced projections 92, supporting a like plurality of electromagnets 94 which are generally cylindrical and partially surrounded by the respective permanent magnets 90. At least one, preferably two, diametrically opposed pilot windings, one for each circular array of the electromagnets 92, indicated at A, B and C, (FIG. 11), are supported by the inner rotor 46 for sensing magnetic flux and reversing current direction in the wiring circuit, indicated generally at 96.

The circuit 96 comprises a pair of wires 98 and 100 connected with a source of direct current, such as a battery, not shown, with a control rheostat 102 interposed in the wire 98. The wires 98 and 100 are respectively connected with the emitters of a NPN transistor 104 and PNP transistor 106 having their collectors respectively connected with the normally closed contacts 108 and 110 or a relay R. The relay R is energized by the battery. The relay armatures are respectively connected with opposing ends of the electromagnets 90 through a slip ring 112 in the manner illustrated.

A branch wire 114, connected with the source wire 100, is connected with the emitter of a PNP transistor 116 having its collector connected by a wire 118 with the source wire 98 between the transistor 104 and relay contact 108. Similarly, a branch wire 120, connected the source wire 98, is connected with the emitter of a NPN transistor 122 having its collector connected by a wire 124 with the wire 100 between the transistor 116 and the relay contact 110. A variable capacitor 126 bridges the wires 118 and 124 at their connection with the source wires. A capacitor 128 bridges the collectors of the transistors 104 and 106. Pilot winding leads 130 and 132, connected with the respective ends of the series connected coils forming pilot windings A, B and C, are connected with the bases of the transistors 104 and 106 through a slip ring 134 and with the bases of the transistors 116 and 122 by branch leads 136 and 138. Another capacitor 140 bridges the transistor leads 136 and 138.

The relay R, electromagnets 90 and variable capacitor 126 forms a tank circuit. A solenoid 139 has its coil connected with the pilot winding wires 130 and 132 through a full wave rectifier 142. The armature of the solenoid 139 adjusts the arm of the variable capacitor 126 to maintain a resonant frequency in the tank circuit in accordance with the RPM of the rotor 46.

Angular rotation of the rotor 46 is started by applying an external source of direct current through a commutator strip, not shown, to the wires 130 and 132 which applies current to the base of each transistor 104 and 106 to render them conductive. Current then flows, in one direction, from the source wires 98 and 100 through these two transistors, the relay contacts and to the electromagnets 94 so that the poles of the electromagnets 94 are attracted by opposite poles of the permanent magnets 90 wherein, as the electromagnets move with respect to the permanent magnets, the current direction is reversed and applied to the bases of the transistors 116 and 122 to render them conductive and apply current from the source wires 98 and 100 in an opposite direction through the electromagnets 94 so that their poles are then attracted by the poles of the next adjacent permanent magnet 90. This cycle of the starting operation is repeated until angular velocity of the rotor 46 is sufficient for the pilot windings A, B and C, by sending magnetic flux, to respectively change the direction of current via the transistors in accordance with the relative position of the electromagnets with respect to the permanent magnets and continue rotation of the rotor. The pilot windings A, B and C form a sign wave which is squared before applied to the transistor bases to achieve abrupt reversal of current direction. The external starting power is then disconnected and the solenoid 139 functions to maintain a resonant frequency in the tank circuit in accordance with the RPM of the rotor. The rheostat 102 is utilized to maintain a desired velocity of the rotors.

The rotating member 84 of the cabin gyroscopes 78 and 80 are driven by magnetic means identical with that described herein above for the rotors 24 and 46.

### Operation

Experiments carried out by George Smoot and Jon Aymon, as written in the book; Wrinkles in Time by George Smoot and Keay Davidson, The Cosmic Background Explorer (COBE) were basically a study of the temperature variations (warmer and colder spots in space, relative to 2.73 degrees Kelvin, of that space) of the background radiation left by the Big Bang. The cosmic microwave temperature variations were very small, only one part in 1000 compared to 2.73 Kelvin average temperature of the radiation field. A map of the temperatures variations was made, and George Smoot referred to the map as a map of The Wrinkles in Time.

The cosmic background does not rotate nor move in any direction. Therefore, the cosmic background is the basis for an inertial frame of reference, that stands absolutely still, with absolute space. Here is a quote from the book Wrinkles in Time by George Smoot and Keay Davidson Avon Books page 137. “Not only is the entire galaxy rotating, as it should be, but, unexpectedly, it is also moving through space. And it is moving very fast—six hundred kilometers a second, or more than a million miles an hour.”

The galaxy referred to above is the Milky Way. Therefore, the Earth is moving through space, relative to the cosmic background, an absolute inertial frame of reference, that stands absolutely still, with a velocity of plus or minus six hundred thousand meters per second.

Now supposition are to be included, in order to enable any person who reads this text, with a minimal skill of the art, to which the invention pertains, will understand, how to build, start, operate and maneuver over the surface of the earth in any direction, landing, takeoff and the how and why, the spacecraft 15 will work.

Suppose one is in space, on the flat two dimension infinite plane, that exists in space, and is not in motion, relative to, at rest, which is, the absolute inertial frame of reference. Suppose that the plane has a hard surface, that one could roll a wheel on. Now, if one takes a wheel with a radius of 3.133 units, of desired measure, being either feet or meters etc. Suppose one holds the axle, that extends through the bearings in the center and roll the wheel in a straight line, with a velocity to make the wheel roll one revolution in each second. It is known that all particles in the wheel are now rotating in a two dimensional plane, perpendicular to the flat plane of space, relative to absolute space. The particles on the bottom of the wheel, while touching the plane, are stopped, relative to the plane at rest. It is also known that the axle is moving 19.685 units, for each rotation of the wheel, per second. The particles at the top are moving 39.37 units per second. Therefore, the maximum velocity that the wheel could go, accelerated by the axle, to maintain an imaginary contact and roll across the space plane, like an automobile tire on the highway, would be 0.5 the speed of light for the axle, while all particles at the very top of the wheel are moving at the speed of light. Although the gravitational mass of the wheel did not change, the inertial mass went to a maximum, that would prevent any additional acceleration to the system. Meaning that no amount of additional force could move the rotating wheel any faster through any two dimensional plane, relative to absolute space.

(Operation, based upon Newton's Fundamental Laws of Motion, begins on page 13 line 13.) Now suppose, the axle of the wheel is turned to point in the direction of motion. Now all particles remain rotating with the same angular velocity, but are now moving in three dimensions, relative to absolute space. It is known that the maximum velocity, that the particles at the top of the wheel, rotating in two dimensions, is twice the speed of the axle or 39.37 units per sec. However, now all particles are rotating in a helix with a velocity of about 27.838 units per sec. more or less, relative to absolute space. Now, if 39.37=1 being the speed of light. The maximum velocity for the wheel rotating in three dimensions is 27.838/39.37=0.707 of 1 being the speed of light.

Thus, the spinning wheel that could only move through space with a maximum velocity of 0.5 the speed of light can now be accelerated to 0.7 of the speed of light before the inertial mass stops the acceleration. What if the angular velocity of the wheel rotating in three dimensions is increased to a predetermined desired rpm, to speed up all the particles in the wheel. Now, what if the axis is rotated back to its former position, forcing all particles, to again move in two dimensions? There would be a rapid deceleration of the (wheel) or craft 15 through space. Suppose the craft 15 was setting on the backside of the Earth on its journey through space. The craft 15 would suddenly rise up, as if by some magical force, such as, antigravity lifted the thing off the ground. The craft 15 would actually be slowing down relative to the constant velocity of the earth, in its journey through absolute space. Due to the fact that the inertial mass of the craft is increasing beyond the ability of the Earth's gravity to accelerate it. All that is needed for the craft 15 to rise up, is a little over 16 feet in the first second.

Technology has advanced rapidly in the last 30 years. It is believed today, that, manufacturers could build a spacecraft 15, that will handle the stress involved, in operating the spacecraft 15 as desired. Therefore, most of the drawings and text originally drawn and written, will be used in this patent application. Although, modem methods of construction would be used when built. The craft 15 could be built, and operated as follows:

All spacecraft 15 should be built with the mass of the rotors 24 and 46 be equal at the desired radius of the craft 15. The reason, for the mass to be equal, is to cancel out all gyroscopic effects, that each rotor will have, as the rotors 24 and 46 counter rotate. Each rotor, will cancel the undesirable gyroscopic twists, that the 14 other produces, during operation.

The external gyroscopes 78 and 80 are used to prevent any rotation of the cabin 64. In an emergency, to prevent cabin 64 from rotating, brake 63 or 63A (Not shown,) will provide positive spin control to either rotor 24 or rotor 46.

During any deceleration of rotor 46, the R relay is released, to allow the contacts to leads 150 and 152, to supply a charging current, to the batteries.

Within the craft, would be an absolute motion detector. The device could be built by having a support bar attached and rotate within gimbals. Two gyroscope rotors, mounted on the support bar, axis adjacent axis, that counter rotate, attached fixed and aligned with the support bar, on one end of the support bar, and a weight on the other end, to balance the support bar. The two, side by side, rotors, aligned with the support bar, would always follow, behind the counter weight. The weight to balance the support bar, would be in front to point the way, through absolute space. This information, along with all other data required, would be sent to the onboard computer, that would control the operation of spacecraft 15, as desired, by the pilot. (Not shown).

The design of the craft 15, as shown in FIG. 1, should be as flat, as possible, on the bottom, with the top remaining close to the same. This would allow a low pressure area to form above the craft 15, and a high pressure to form below the craft 15 when in operation, the same effects, as the design for, an airplane wing.

Cabin 64 is supported within the craft 15, by hydraulic cylinders 74, on the top and hydraulic cylinders 76, on the bottom. When the pilot sends the order to take off, whether it is, to be slow or fast, the computer will select the cylinders 74 and 76, as required, to either support, or do not support, the gravitational mass or weight of cabin 64. The weight of the cabin, will turn the axis of rotation 18, of craft 15, the desired amount. While at the same time, prior, the computer may call for an increase, of the angular velocity, of rotors 24 and 46, to increase stored fall.

With the ability of the craft 15 to slow its center of mass fall through space, it could easily overcome the gravitational attracting force, of the earth's gravity, which is 16 feet in the first second. With every second being a first second for the gravitational attracting force of the earth. The craft 15 could gain altitude rapidly. With the aerodynamics of craft 15 as proposed. With low air pressure above and high air pressure below, craft 15 could maintain altitude, and coast with the use of, the force of gravity, to accelerate its lateral motion, to any point, desired on earth.

It should be appreciated that the drawings could be magnetic with a backup bumper, of ball bearings, under extreme stress.

Newton's fundamental laws of Motion are used with one exception: All particles that make up the craft 15, move with a constant velocity, The Center Of Mass does not. Now, with the earth as a frame of reference with a wheel having a radius of 3.133 meter rolling on the highway, moving in two dimensions, one rotation each second. Provided that all particles of the wheel are located in the rim, the velocity of the bottom particles are 0, the top particles are moving 39.37 meters second. With the wheel moving in the direction of the axle or spin axis, the rim is rotating in all three dimensions. All particles create a helix with a length of 27.838 meters a second with the center of mass moving 19.685 meters a second. If we calculate the kinetic energy of two opposite particles of the rim moving one revolution a second, relative to the earth, K=½ MV², the only concern is the velocity of the particles in the two and three dimension motions with the centers of mass moving 19.685 meters second. (Top Particle, motion of center of mass=19.685+19,685 motion of rotation. 2D=39.37 squared. Top Particle=1549.9959 Bottom Particle motion of center of mass=19.685−19.685 motion of rotation=O. Total V² for 2D, Top and Bottom Particles.=1549.9959) (3D=center of mass motion 19.685+8.153*arc length, to complete helix, of two particles, one rotation=27.838 meters V²=774.9542×2=1549.908 Total.) Close enough to say that the kinetic energy of the two rings are equivalent.

The Milky Way galaxy is moving 600 kilometers/sec. toward Leo, while rotating 250 kilometers/sec. The Earth and solar system have a net velocity of 600−250=350 kilometers/sec. Less 30 kilometers for the Earth's orbit around the Sun. The Earth's minimum velocity toward Leo is 320,000 meters second.

When the frame of reference is the cosmic background instead of the Earth, the arc length needed over 320,000 meters to complete the helix, would be like a straight line, when calculated, it turns out to be needing only 0.00026 + or − meters to complete the helix. Within that difference of 8.153 meters, that is reduced to 0.00026 meters, when moving 320,000 meters each second, is the reason why the center of mass of the rim when rotating in three dimensions, must decelerate when tilted into two dimensional motion.

To calculate the amount of deceleration from 3d to 2d. By using a rim with a circumference of 20 meter, rotating one revolution a second. The velocities would be, for particles rotating in 2D. Bottom 320,000+20 for center of mass, less 20 for reverse rotation=320,000+0 for bottom. Middle particles+20 for particles in line with the center of mass=320.000+20 for middle. Top particles+20 for center of mass motion, and +20 for forward rotation=320,000+40 for top particles. 3D all particles are moving 320,000+20.00026. By omitting 320,000. By separating the 2D rim into particles, having velocities of 1 to 39, on each side, then including 0 and 40, =80 particles with the velocity as the number. The total sum of the V² of all 80 particles in 2D motion is 42,680. Velocity of 3D particle=20.00026²=400.01×80=32,000.832 total V² of all 3D particles. Now 42,680 less 32,000.832=10 10,679.168 is amount of V² that 2D is greater than 3D. Divide 10,679.168 by 80=133.489 is the amount of V², that each particle of 2D is greater than V² of each particle of 3D. The square root of 133.489=11.553, each particle of 2D has 11.553 meters of stored energy, greater than 3D over the distance of 320,000 meters.

Therefore, when the craft 15 is moving in 3D, all particles are moving with a velocity of 320,020.00026 meters per second. When the axis is tilted 90 degrees into full 2D motion, the craft resists a change in velocity, i.e., Inertial Mass. All particles that make up the craft continue on through space with the same velocity of 320,020.000.26 meters second. However, the center of mass was moving 320,020 meter a second, but now is moving slower by 11.553 meters at 320008.447 meters per second, in 2D motion, to obey the Conservation of Energy Law.

Suppose a craft 15 with a circumference of 80 meters is rotating 2 revolutions per second. How much tilt, to the spin axis, would be needed, for craft 15, to take off from earth?

$$\frac{92.424 meters}{4.9 meters} \frac{90 degrees}{X = 4.77}$$

Degrees tilt plus, and the craft 15 is off the ground. Thus, it is evident from the mathematics, in order to obey the Conservation of Energy Law and the Conservation of Momentum Law. When the Craft 15, rotating in 3D, then tilted into 2D, the center of mass of the Craft 15, must reduce velocity, relative to, the absolute frame of reference, to obey the Laws.

Although the craft 15 has been referred to as being on the back side of the Earth relative to the absolute frame of reference, then accelerating the rotors to store fall distance or deceleration in the counter rotating rotors to slow down with a greater rate than the Earth's gravitational force can accelerate the craft 15 for take off. To this point, deceleration has been referenced; however, the craft can also store acceleration in the 2D rotation. Suppose that the craft 15 is on the front side of the Earth in its motion through absolute space. The craft could easily be setting or moving tilted 30 to 50 degrees to absolute space, and the rotors could be accelerated to store acceleration into the 2D motion. Then by tilting the axis back into 3D motion, the craft will accelerate into space at a greater velocity than gravity can pull it back. Thus, not only can 3D store deceleration, 2D can store acceleration that would not only be used for take off, but to maneuver to any location desired.

Previously, a single counter rotating system was described. However, this method of motion may be more suited for multiunit configurations. By using a six sided structure, connected together like a honeycomb, with geodesic domes or other types of structures for covering both sides of each unit, all air could be evacuated from all spaces to allow the counter rotating rotors within each space supported on controlled gimbals to operate without air resistance. With two units, it would be rectangular. Three units, it would be triangular. With four or more units, a craft 15 could be built to any size desired. Therefore, if any unit had mechanical problems, it could be shut down, pressured up with air to go in and fix the problem while on one's way through space.

The power to operate the Resonance Frequency Rotor, as herein above described, could be powered by conventional means.

Obviously, the invention is susceptible to changes or alterations without defeating its practicability. Therefore, we do not wish to be confined to the embodiment shown in the drawings and described herein.

What is claimed is:

1. A vehicle capable of traveling in space with at least two counter rotating rotors to change the inertial mass, to enable suspension above and maneuver over the Earth, comprising:
a generally disk-like, hollow housing, having a thickened hub portion at the spin axis; and
at least one rotor within and diametrically substantially equal, to said housing and means including magnetic attraction and repulsion forces, for angularly rotating said rotor or rotors with respect to said housing or vice versa, whereby the rotational velocity provides an increase or decrease of its inertial mass relative to the absolute inertial frame of reference.

2. The vehicle of claim 1 wherein, when rotating in a three dimensional helix relative to the absolute inertial frame of reference, the counter rotating rotors have an amount of stored deceleration directly proportional to the angular velocities of the counter rotating rotors.

3. The vehicle of claim 1 wherein, when rotating in a two dimensional plane relative to the absolute inertial frame of reference, the counter rotating rotors have an amount of stored acceleration directly proportional to the angular velocities of the counter rotating rotors.

4. The vehicle of claim 1 wherein the vehicle, when rotating in a three dimensional helix, will move with a greater velocity that when the vehicle is rotating in a two dimensional plane, relative to the absolute inertial frame of reference.

5. The vehicle of claim 1 wherein the vehicle, when rotating in a two dimensional plane, will move with less velocity than when rotating in a three dimensional helix, relative to the absolute inertial frame of reference.

6. The vehicle of claim 1 wherein, when the spin axis of the vehicle is changed from rotating in a three dimensional helix to rotating in a two dimensional plane, the vehicle being on the back side of the Earth relative to the absolute inertial frame of reference, will decelerate at a greater rate than the gravitational attraction force of Earth, can accelerate the vehicle.

7. The vehicle of claim 1 wherein the vehicle, when located on the front side of the Earth, relative to the absolute inertial frame of reference, will accelerate at a greater rate than the gravitational attraction of the earth, can decelerate the vehicle. Thus, the vehicle will rise above the surface of the earth to travel in space.

8. The vehicle of claim 1 in which said hub includes a tube to provide a means to evacuate air from the interior of the outer shell.

9. The vehicle of claim 1 further including a second rotor within said housing concentric with the first named rotor and means including bearings connecting each said rotors to said tube.

10. The vehicle of claim 1 further including a cylindrical cabin loosely surrounding said tube normal to its axis. Means concentrically over and underlying the outer peripheral portion of said cabin for connecting it with said tube, and pressure cylinders connecting said cabin to said ring. To provide means for tilting the central axis in the direction designated.

11. The vehicle according to claim 10 further including a pair of diametrically opposed, oppositely rotating gyroscopes mounted on the perimeter of said cabin for preventing angular rotation of said cabin with said rotor or rotors.

12. The vehicle of claim 11 in which said magnetic force means comprises:
a plurality of elongated permanent magnets supported in and to and circumferential spaced relation by one said rotor adjacent the perimeter of said vehicle;
a like plurality of elongated electromagnets supported in end to end circumferential spaced relation by the other said rotor in corporative spaced relation with respect to said permanent magnets and circuit means connecting a source of electrical energy with said electromagnets and including at least one pilot winding sensing the polarity of magnetic flux of all permanent magnets with respect to the polarity of an approaching electromagnet for maintaining or reversing current direction resonant with the spin frequency through the electromagnets in accordance with the desired attractive or repulsive forces between the respective magnets.

13. The vehicle of claim 12 in which said permanent magnets are generally U-shaped in transverse section.

14. The vehicle of claim 13 in which said electromagnets are generally cylindrical.
